(19) United States
(12) Patent Application Publication
(10) Pub. No.: US 2014/0160157 A1
(43) Pub. Date: Jun. 12, 2014

(54) PEOPLE-TRIGGERED HOLOGRAPHIC REMINDERS

(71) Applicants: Adam G. Poulos, Redmond, WA (US); Holly A. Hirzel, Kirkland, WA (US); Anthony J. Ambrus, Seattle, WA (US); Daniel J. McCulloch, Kirkland, WA (US); Brian J. Mount, Seattle, WA (US); Jonathan T. Steed, Redmond, WA (US)

(72) Inventors: Adam G. Poulos, Redmond, WA (US); Holly A. Hirzel, Kirkland, WA (US); Anthony J. Ambrus, Seattle, WA (US); Daniel J. McCulloch, Kirkland, WA (US); Brian J. Mount, Seattle, WA (US); Jonathan T. Steed, Redmond, WA (US)

(21) Appl. No.: 13/711,351

(22) Filed: Dec. 11, 2012

(51) Int. Cl. G06T 19/00

(52) U.S. Cl. CPC G06T 19/006
USPC 345/633

(57) ABSTRACT

Methods for generating and displaying people-triggered holographic reminders are described. In some embodiments, a head-mounted display device (HMD) generates and displays an augmented reality environment to an end user of the HMD in which reminders associated with a particular person may be displayed if the particular person is within a field of view of the HMD or if the particular person is within a particular distance of the HMD. The particular person may be identified individually or identified as belonging to a particular group (e.g., a member of a group with a particular job title such as programmer or administrator). In some cases, a completion of a reminder may be automatically detected by applying speech recognition techniques (e.g., to identify key words, phrases, or names) to captured audio of a conversation occurring between the end user and the particular person.

### BACKGROUND

Augmented reality (AR) relates to providing an augmented real-world environment where the perception of a real-world environment (or data representing a real-world environment) is augmented or modified with computer-generated virtual data. For example, data representing a real-world environment may be captured in real-time using sensory input devices such as a camera or microphone and augmented with computer-generated virtual data including virtual images and virtual sounds. The virtual data may also include information related to the real-world environment such as a text description associated with a real-world object in the real-world environment. The objects within an AR environment may include real objects (i.e., objects that exist within a particular real-world environment) and virtual objects (i.e., objects that do not exist within the particular real-world environment).

In order to realistically integrate virtual objects into an AR environment, an AR system typically performs several tasks including mapping and localization. Mapping relates to the process of generating a map of a real-world environment. Localization relates to the process of locating a particular point of view or pose relative to the map of the real-world environment. In some cases, an AR system may localize the pose of a mobile device moving within a real-world environment in real-time in order to determine the particular view associated with the mobile device that needs to be augmented as the mobile device moves within the real-world environment.

### SUMMARY

Technology is described for generating and displaying people-triggered holographic reminders. In some embodiments, a head-mounted display device (HMD) generates and displays an augmented reality environment to an end user of the HMD in which reminders associated with a particular person may be displayed if the particular person is within a field of view of the HMD (e.g., determined using facial recognition techniques) or if the particular person is within a particular distance of the HMD. The particular person may be identified individually or identified as belonging to a particular group (e.g., a member of a group with a particular job title such as programmer or administrator). In some cases, a completion of a reminder may be automatically detected by applying speech recognition techniques (e.g., to identify key words, phrases, or names) to captured audio of a conversation occurring between the end user and the particular person.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a networked computing environment in which the disclosed technology may be practiced.

FIG. 2A depicts one embodiment of a mobile device in communication with a second mobile device.

FIG. 2B depicts one embodiment of a portion of an HMD.

FIG. 2C depicts one embodiment of a portion of an HMD in which gaze vectors extending to a point of gaze are used for aligning a far inter-pupillary distance (IPD).

FIG. 2D depicts one embodiment of a portion of an HMD in which gaze vectors extending to a point of gaze are used for aligning a near inter-pupillary distance (IPD).

FIG. 2E depicts one embodiment of a portion of an HMD with movable display optical systems including gaze detection elements.

FIG. 2F depicts an alternative embodiment of a portion of an HMD with movable display optical systems including gaze detection elements.

FIG. 2G depicts one embodiment of a side view of a portion of an HMD.

FIG. 2H depicts one embodiment of a side view of a portion of an HMD which provides support for a three dimensional adjustment of a microdisplay assembly.

FIG. 3 depicts one embodiment of a computing system including a capture device and computing environment.

FIGS. 4A-4B depict various embodiments of various augmented reality environments in which people-triggered holographic reminders may be used.

FIG. 5 is a flowchart describing one embodiment of a method for generating and displaying people-triggered holographic reminders.

FIG. 6A is a flowchart describing one embodiment of a process for determining one or more reminders.

FIG. 6B is a flowchart describing one embodiment of a process for detecting a second person within an environment.

FIG. 6C is a flowchart describing one embodiment of a process for automatically detecting the completion of a reminder.

FIG. 7 is a flowchart describing an alternative embodiment of a method for generating and displaying people-triggered holographic reminders.

FIG. 8 is a block diagram of one embodiment of a mobile device.

### DETAILED DESCRIPTION

Technology is described for generating and displaying people-triggered holographic reminders. In some embodiments, a mobile device, such as a head-mounted display device (HMD), may acquire one or more reminders associated with an end user of the mobile device, identify a particular person within an environment, prioritize the one or more reminders based on the identification of the particular person, and display a subset of the one or more reminders to the end user based on the prioritization of the one or more reminders. The one or more reminders may be determined based on tasks entered into or accessible from a personal information manager, task manager, email application, calendar application, social networking application, software bug tracking application, issue tracking application, and/or time management application. Each of the one or more reminders may correspond with a particular task to be completed, one or more people associated with the particular task, a location associated with the particular task, a reminder frequency (e.g., that a particular reminder is issued every two weeks), and/or a completion time for the particular task. The particular person may be identified individually or identified as belonging to a particular group (e.g., a member of a group with a particular job title such as programmer or administrator).

In some embodiments, an HMD may provide an augmented reality environment to an end user of the HMD in which reminders associated with a particular person may be displayed if the particular person is within a field of view of the HMD (e.g., determined using facial recognition techniques) or if the particular person is within a particular distance of the HMD (e.g., determined using GPS location information corresponding with a second mobile device associated with the particular person). In one example, if the end user of the HMD owes a particular person money, then if the particular person is within a field of view of the HMD, then the HMD may display a reminder to the end user that they owe the particular person money.

In some embodiments, an HMD may acquire a second set of reminders associated with a particular person different from the end user of the HMD from a second mobile device associated with the particular person and provide an augmented reality environment to the end user in which the second set of reminders (or a subset thereof) may be displayed if the particular person is within a field of view of the HMD or if the particular person is within a particular distance of the HMD. In some cases, one or more virtual objects corresponding with the second set of reminders may be displayed to the end user. In one example, the one or more virtual objects may provide reminder information that the particular person would like to speak with the end user regarding a particular topic. In another example, the one or more virtual objects may provide task related information (e.g., if and when the particular person will be on vacation next or the next meeting in which both the end user and the particular person will be participants). The one or more virtual objects may also provide links to content (e.g., a photo or image) to be shared between the end user and the particular person. The one or more virtual objects may also provide links to online shopping websites (e.g., to facilitate completion of a task associated with buying a gift).

In some embodiments, a completion of a reminder may be automatically detected by applying speech recognition techniques (e.g., to identify key words, phrases, or names) to captured audio of a conversation occurring between the end user and the particular person.

One issue with managing a large number of reminders is that it may be difficult to track and recall one of the large number of reminders at the right time or at a time that is most efficient in order to complete a task associated with the reminder (e.g., personally saying “Happy Birthday” to a friend who is nearby). Thus, there is a need for generating and displaying people-triggered holographic reminders that takes into account end user context and the presence of other people within a common environment.

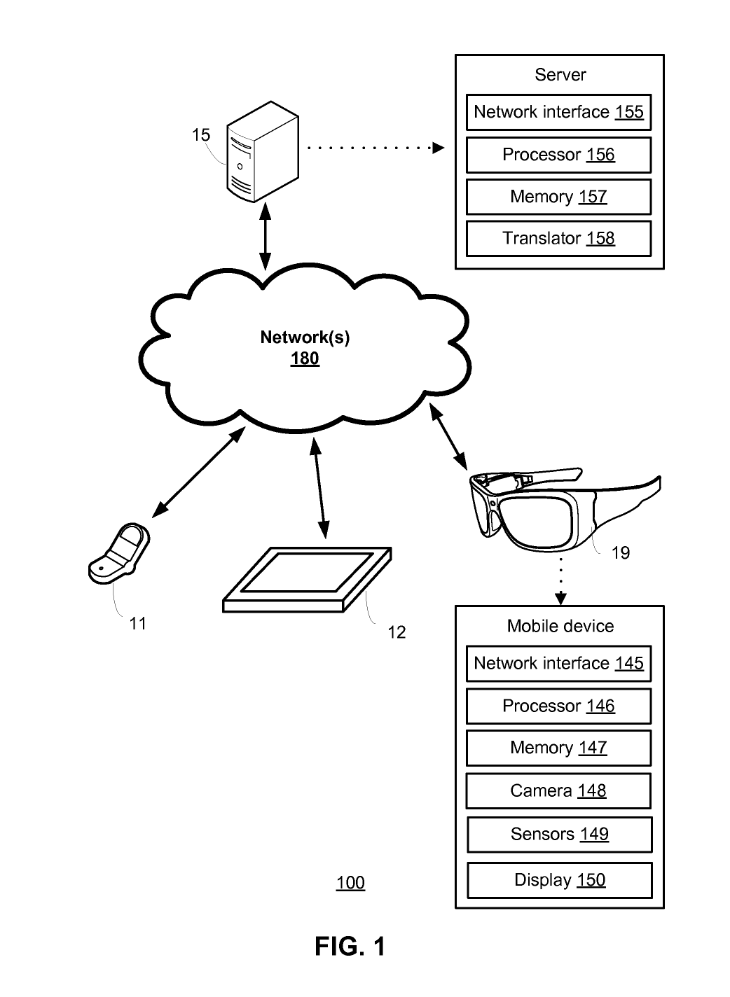

FIG. 1 is a block diagram of one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. The depicted computing devices include mobile device 11, mobile device 12, mobile device 19, and server 15. In some embodiments, the plurality of computing devices may include other computing devices not shown. In some embodiments, the plurality of computing devices may include more than or less than the number of computing devices shown in FIG. 1. The one or more networks 180 may include a secure network such as an enterprise private network, an unsecure network such as a wireless open network, a local area network (LAN), a wide area network (WAN), and the Internet. Each network of the one or more networks 180 may include hubs, bridges, routers, switches, and wired transmission media such as a wired network or direct-wired connection.

Server 15, which may comprise a supplemental information server or an application server, may allow a client to download information (e.g., text, audio, image, and video files) from the server or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of server 15 includes a network interface 155, processor 156, memory 157, and translator 158, all in communication with each other. Network interface 155 allows server 15 to connect to one or more networks 180. Network interface 155 may include a wireless network interface, a modem, and/or a wired network interface. Processor 156 allows server 15 to execute computer readable instructions stored in memory 157 in order to perform processes discussed herein. Translator 158 may include mapping logic for translating a first file of a first file format into a corresponding second file of a second file format (i.e., the second file may be a translated version of the first file). Translator 158 may be configured using file mapping instructions that provide instructions for mapping files of a first file format (or portions thereof) into corresponding files of a second file format.

One embodiment of mobile device 19 includes a network interface 145, processor 146, memory 147, camera 148, sensors 149, and display 150, all in communication with each other. Network interface 145 allows mobile device 19 to connect to one or more networks 180. Network interface 145 may include a wireless network interface, a modem, and/or a wired network interface. Processor 146 allows mobile device 19 to execute computer readable instructions stored in memory 147 in order to perform processes discussed herein. Camera 148 may capture color images and/or depth images. Sensors 149 may generate motion and/or orientation information associated with mobile device 19. In some cases, sensors 149 may comprise an inertial measurement unit (IMU). Display 150 may display digital images and/or videos. Display 150 may comprise a see-through display.

In some embodiments, various components of mobile device 19 including the network interface 145, processor 146, memory 147, camera 148, and sensors 149 may be integrated on a single chip substrate. In one example, the network interface 145, processor 146, memory 147, camera 148, and sensors 149 may be integrated as a system on a chip (SOC). In other embodiments, the network interface 145, processor 146, memory 147, camera 148, and sensors 149 may be integrated within a single package.

In some embodiments, mobile device 19 may provide a natural user interface (NUI) by employing camera 148, sensors 149, and gesture recognition software running on processor 146. With a natural user interface, a person's body parts and movements may be detected, interpreted, and used to control various aspects of a computing application. In one example, a computing device utilizing a natural user interface may infer the intent of a person interacting with the computing device (e.g., that the end user has performed a particular gesture in order to control the computing device).

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer networking diagrams to depict the Internet as an abstraction of the underlying infrastructure it represents.

In one example, mobile device 19 comprises a head-mounted display device (HMD) that provides an augmented reality environment or a mixed reality environment to an end user of the HMD. The HMD may comprise a video see-through and/or an optical see-through system. An optical see-through HMD worn by an end user may allow actual direct viewing of a real-world environment (e.g., via transparent lenses) and may, at the same time, project images of a virtual object into the visual field of the end user thereby augmenting the real-world environment perceived by the end user with the virtual object.

Utilizing an HMD, an end user may move around a real-world environment (e.g., a living room) wearing the HMD and perceive views of the real-world overlaid with images of virtual objects. The virtual objects may appear to maintain coherent spatial relationship with the real-world environment (i.e., as the end user turns their head or moves within the real-world environment, the images displayed to the end user will change such that the virtual objects appear to exist within the real-world environment as perceived by the end user). The virtual objects may also appear fixed with respect to the end user's point of view (e.g., a virtual menu that always appears in the top right corner of the end user's point of view regardless of how the end user turns their head or moves within the real-world environment). In one embodiment, environmental mapping of the real-world environment may be performed by server 15 (i.e., on the server side) while camera localization may be performed on mobile device 19 (i.e., on the client side). The virtual objects may include a text description associated with a real-world object.

In some embodiments, a mobile device, such as mobile device 19, may be in communication with a server in the cloud, such as server 15, and may provide to the server location information (e.g., the location of the mobile device via GPS coordinates) and/or image information (e.g., information regarding objects detected within a field of view of the mobile device) associated with the mobile device. In response, the server may transmit to the mobile device one or more virtual objects based upon the location information and/or image information provided to the server. In one embodiment, the mobile device 19 may specify a particular file format for receiving the one or more virtual objects and server 15 may transmit to the mobile device 19 the one or more virtual objects embodied within a file of the particular file format.

In some embodiments, a mobile device, such as mobile device 19, may provide an augmented reality environment to an end user of the mobile device (e.g., via a see-through display) in which reminders associated with a particular person may be displayed if the particular person is within a field of view of the mobile device (e.g., determined using facial recognition techniques) or if the particular person is within a particular distance of the mobile device (e.g., determined using GPS location information corresponding with both the mobile device and a second mobile device associated with the particular person). The mobile device may acquire a second set of reminders associated with a particular person different from the end user from a second mobile device associated with the particular person and provide an augmented reality environment to the end user in which the second set of reminders (or a subset thereof) may be displayed if the particular person is within a field of view of the mobile device or if the particular person is within a particular distance of the mobile device. In some cases, a completion of a reminder may be automatically detected by applying speech recognition techniques (e.g., to identify key words, phrases, or names) to captured audio of a conversation occurring between the end user and the particular person.

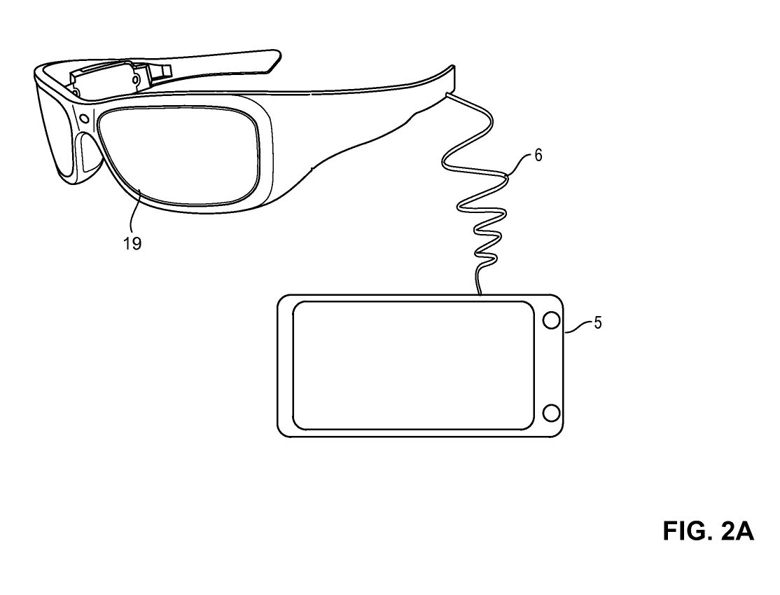

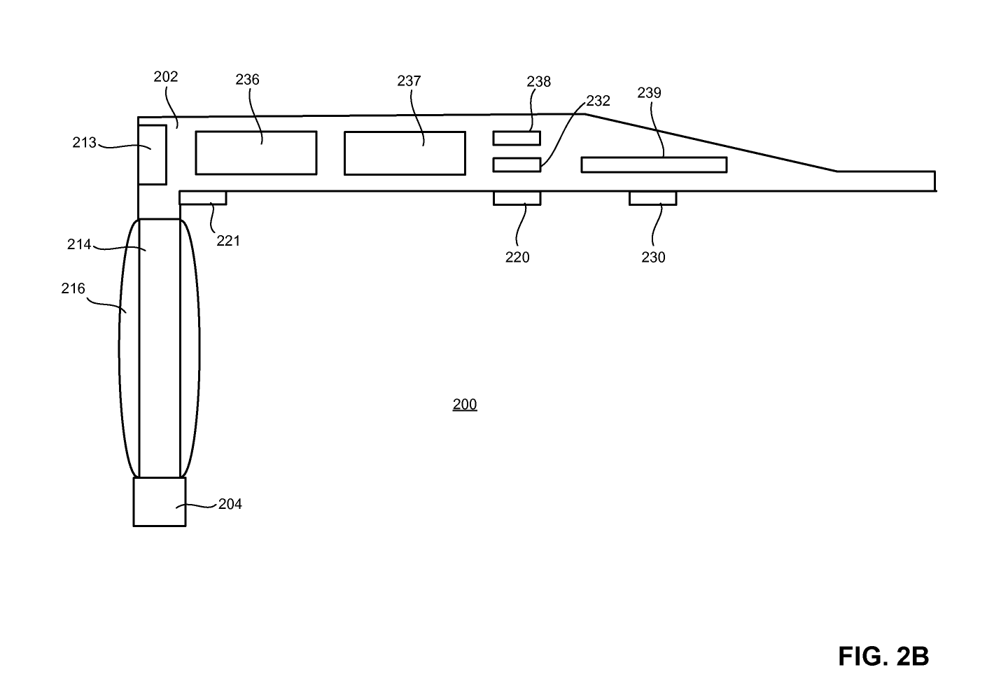

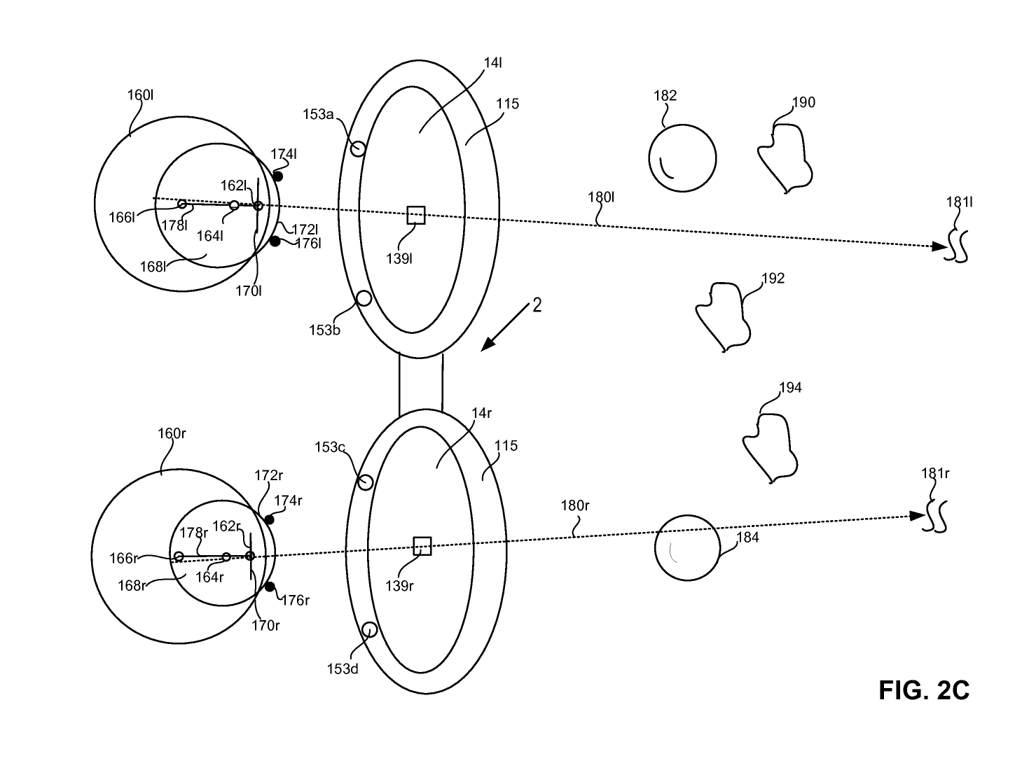

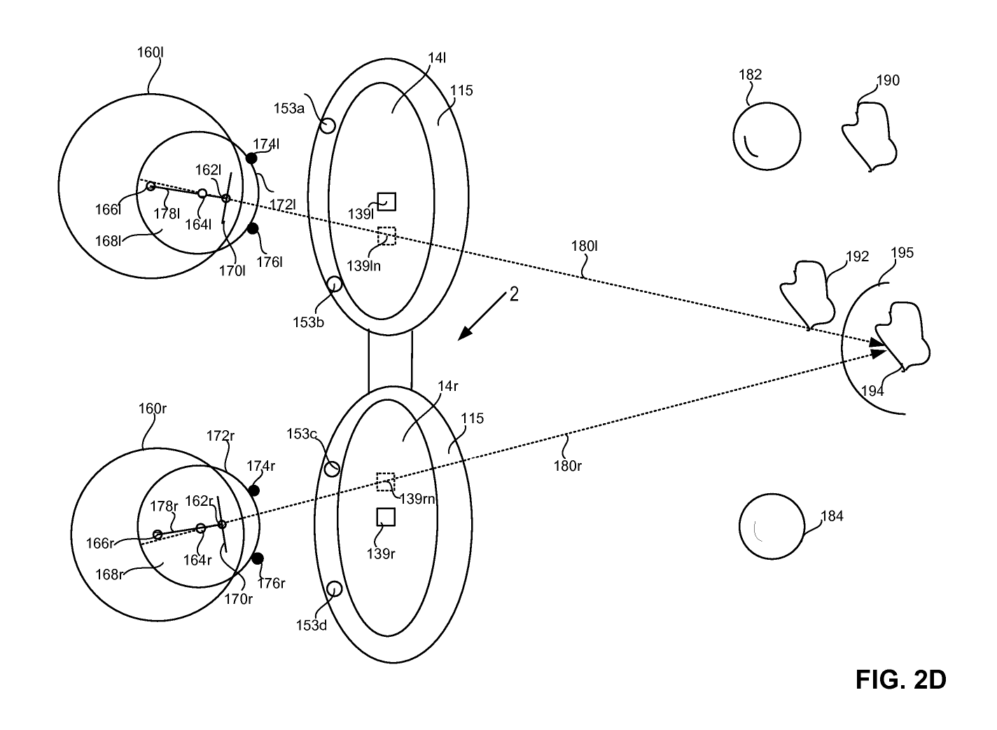

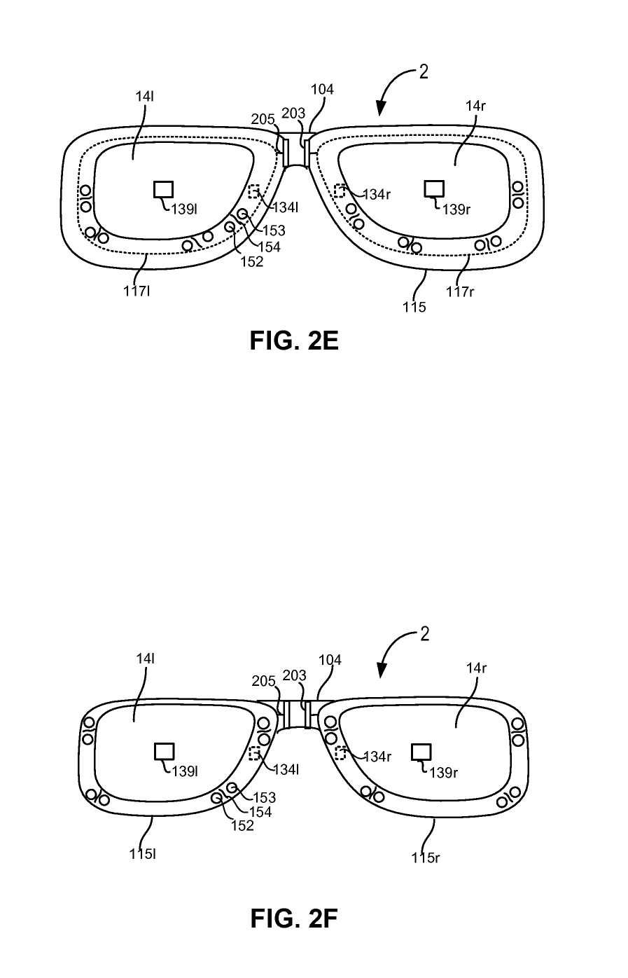

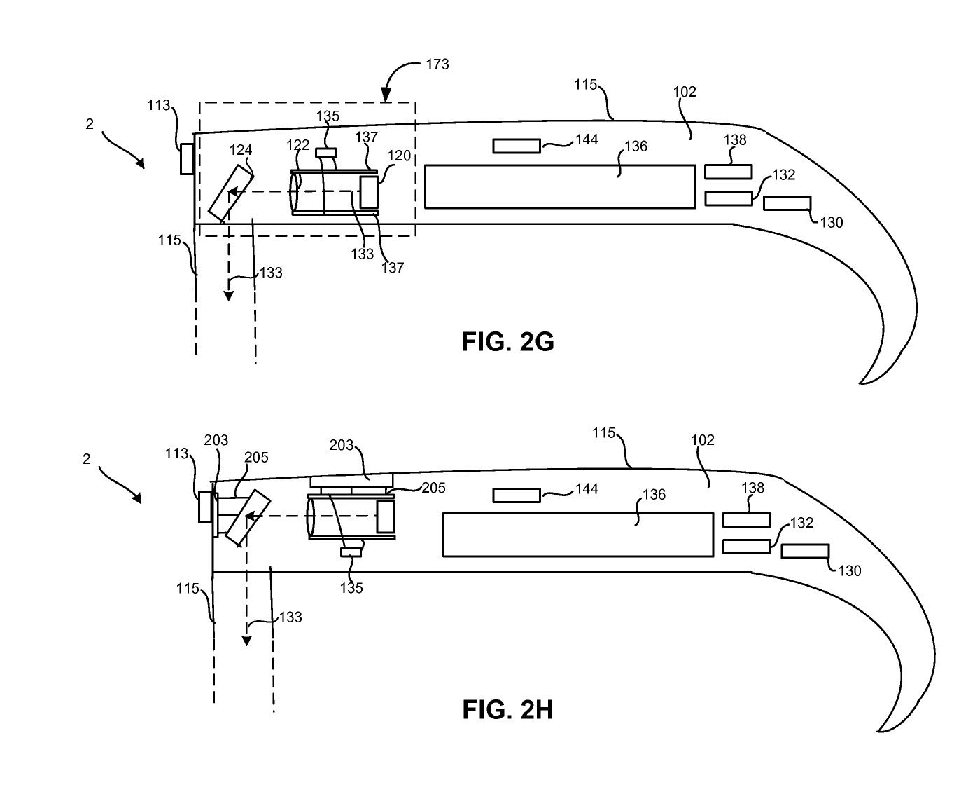

FIG. 2A depicts one embodiment of a mobile device 19 in communication with a second mobile device 5. Mobile device 19 may comprise a see-through HMD. As depicted, mobile device 19 communicates with mobile device 5 via a wired connection 6. However, the mobile device 19 may also communicate with mobile device 5 via a wireless connection. Mobile device 5 may be used by mobile device 19 in order to offload compute intensive processing tasks (e.g., the rendering of virtual objects) and to store virtual object information and other data that may be used to provide an augmented reality environment on mobile device 19. Mobile device 5 may also provide motion and/or orientation information associated with mobile device 5 to mobile device 19. In one example, the motion information may include a velocity or acceleration associated with the mobile device 5 and the orientation information may include Euler angles, which provide rotational information around a particular coordinate system or frame of reference. In some cases, mobile device 5 may include a motion and orientation sensor, such as an inertial measurement unit (IMU), in order to acquire motion and/or orientation information associated with mobile device 5.

FIG. 2B depicts one embodiment of a portion of an HMD, such as mobile device 19 in FIG. 1. Only the right side of an HMD 200 is depicted. HMD 200 includes right temple 202, nose bridge 204, eye glass 216, and eye glass frame 214. Right temple 202 includes a capture device 213 (e.g., a front facing camera and/or microphone) in communication with processing unit 236. The capture device 213 may include one or more cameras for recording digital images and/or videos and may transmit the visual recordings to processing unit 236. The one or more cameras may capture color information, IR information, and/or depth information. The capture device 213 may also include one or more microphones for recording sounds and may transmit the audio recordings to processing unit 236.

Right temple 202 also includes biometric sensor 220, eye tracking system 221, ear phones 230, motion and orientation sensor 238, GPS receiver 232, power supply 239, and wireless interface 237, all in communication with processing unit 236. Biometric sensor 220 may include one or more electrodes for determining a pulse or heart rate associated with an end user of HMD 200 and a temperature sensor for determining a body temperature associated with the end user of HMD 200. In one embodiment, biometric sensor 220 includes a pulse rate measuring sensor which presses against the temple of the end user. Motion and orientation sensor 238 may include a three axis magnetometer, a three axis gyro, and/or a three axis accelerometer. In one embodiment, the motion and orientation sensor 238 may comprise an inertial measurement unit (IMU). The GPS receiver may determine a GPS location associated with HMD 200. Processing unit 236 may include one or more processors and a memory for storing computer readable instructions to be executed on the one or more processors. The memory may also store other types of data to be executed on the one or more processors.

In one embodiment, the eye tracking system 221 may include an inward facing camera. In another embodiment, the eye tracking system 221 may comprise an eye tracking illumination source and an associated eye tracking IR sensor. In one embodiment, the eye tracking illumination source may include one or more infrared (IR) emitters such as an infrared light emitting diode (LED) or a laser (e.g. VCSEL) emitting about a predetermined IR wavelength or a range of wavelengths. In some embodiments, the eye tracking sensor may include an IR camera or an IR position sensitive detector (PSD) for tracking glint positions. More information about eye tracking systems can be found in U.S. Pat. No. 7,401,920, entitled “Head Mounted Eye Tracking and Display System”, issued Jul. 22, 2008, and U.S. patent application Ser. No. 13/245,700, entitled “Integrated Eye Tracking and Display System,” filed Sep. 26, 2011, both of which are herein incorporated by reference.

In one embodiment, eye glass 216 may comprise a see-through display, whereby images generated by processing unit 236 may be projected and/or displayed on the see-through display. The capture device 213 may be calibrated such that a field of view captured by the capture device 213 corresponds with the field of view as seen by an end user of HMD 200. The ear phones 230 may be used to output sounds associated with the projected images of virtual objects. In some embodiments, HMD 200 may include two or more front facing cameras (e.g., one on each temple) in order to obtain depth from stereo information associated with the field of view captured by the front facing cameras. The two or more front facing cameras may also comprise 3D, IR, and/or RGB cameras. Depth information may also be acquired from a single camera utilizing depth from motion techniques. For example, two images may be acquired from the single camera associated with two different points in space at different points in time. Parallax calculations may then be performed given position information regarding the two different points in space.

In some embodiments, HMD 200 may perform gaze detection for each eye of an end user's eyes using gaze detection elements and a three-dimensional coordinate system in relation to one or more human eye elements such as a cornea center, a center of eyeball rotation, or a pupil center. Gaze detection may be used to identify where the end user is focusing within a field of view. Examples of gaze detection elements may include glint generating illuminators and sensors for capturing data representing the generated glints. In some cases, the center of the cornea can be determined based on two glints using planar geometry. The center of the cornea links the pupil center and the center of rotation of the eyeball, which may be treated as a fixed location for determining an optical axis of the end user's eye at a certain gaze or viewing angle.

FIG. 2C depicts one embodiment of a portion of an HMD 2 in which gaze vectors extending to a point of gaze are used for aligning a far inter-pupillary distance (IPD). HMD 2 is one example of a mobile device, such as mobile device 19 in FIG. 1. As depicted, gaze vectors 180l and 180r intersect at a point of gaze that is far away from the end user (i.e., the gaze vectors 180l and 180r do not intersect as the end user is looking at an object far away). A model of the eyeball for eyeballs 160l and 160r is illustrated for each eye based on the Gullstrand schematic eye model. Each eyeball is modeled as a sphere with a center of rotation 166 and includes a cornea 168 modeled as a sphere having a center 164. The cornea 168 rotates with the eyeball, and the center of rotation 166 of the eyeball may be treated as a fixed point. The cornea 168 covers an iris 170 with a pupil 162 at its center. On the surface 172 of each cornea are glints 174 and 176.

As depicted in FIG. 2C, a sensor detection area 139 (i.e., 139l and 139r, respectively) is aligned with the optical axis of each display optical system 14 within an eyeglass frame 115. In one example, the sensor associated with the detection area may include one or more cameras capable of capturing image data representing glints 174l and 176l generated respectively by illuminators 153a and 153b on the left side of the frame 115 and data representing glints 174r and 176r generated respectively by illuminators 153c and 153d on the right side of the frame 115. Through the display optical systems 14l and 14r in the eyeglass frame 115, the end user's field of view includes both real objects 190, 192, and 194 and virtual objects 182 and 184.

The axis 178 formed from the center of rotation 166 through the cornea center 164 to the pupil 162 comprises the optical axis of the eye. A gaze vector 180 may also be referred to as the line of sight or visual axis which extends from the fovea through the center of the pupil 162. In some embodiments, the optical axis is determined and a small correction is determined through user calibration to obtain the visual axis which is selected as the gaze vector. For each end user, a virtual object may be displayed by the display device at each of a number of predetermined positions at different horizontal and vertical positions. An optical axis may be computed for each eye during display of the object at each position, and a ray modeled as extending from the position into the user's eye. A gaze offset angle with horizontal and vertical components may be determined based on how the optical axis must be moved to align with the modeled ray. From the different positions, an average gaze offset angle with horizontal or vertical components can be selected as the small correction to be applied to each computed optical axis. In some embodiments, only a horizontal component is used for the gaze offset angle correction.

As depicted in FIG. 2C, the gaze vectors 180l and 180r are not perfectly parallel as the vectors become closer together as they extend from the eyeball into the field of view at a point of gaze. At each display optical system 14, the gaze vector 180 appears to intersect the optical axis upon which the sensor detection area 139 is centered. In this configuration, the optical axes are aligned with the inter-pupillary distance (IPD). When an end user is looking straight ahead, the IPD measured is also referred to as the far IPD.

FIG. 2D depicts one embodiment of a portion of an HMD 2 in which gaze vectors extending to a point of gaze are used for aligning a near inter-pupillary distance (IPD). HMD 2 is one example of a mobile device, such as mobile device 19 in FIG. 1. As depicted, the cornea 168l of the left eye is rotated to the right or towards the end user's nose, and the cornea 168r of the right eye is rotated to the left or towards the end user's nose. Both pupils are gazing at a real object 194 within a particular distance of the end user. Gaze vectors 180l and 180r from each eye enter the Panum's fusional region 195 in which real object 194 is located. The Panum's fusional region is the area of single vision in a binocular viewing system like that of human vision. The intersection of the gaze vectors 180l and 180r indicates that the end user is looking at real object 194. At such a distance, as the eyeballs rotate inward, the distance between their pupils decreases to a near IPD. The near IPD is typically about 4 mm less than the far IPD. A near IPD distance criteria (e.g., a point of gaze at less than four feet from the end user) may be used to switch or adjust the IPD alignment of the display optical systems 14 to that of the near IPD. For the near IPD, each display optical system 14 may be moved toward the end user's nose so the optical axis, and detection area 139, moves toward the nose a few millimeters as represented by detection areas 139ln and 139rn.

More information about determining the IPD for an end user of an HMD and adjusting the display optical systems accordingly can be found in U.S. patent application Ser. No. 13/250,878, entitled “Personal Audio/Visual System,” filed Sep. 30, 2011, which is herein incorporated by reference in its entirety.

FIG. 2E depicts one embodiment of a portion of an HMD 2 with movable display optical systems including gaze detection elements. What appears as a lens for each eye represents a display optical system 14 for each eye (i.e., 14l and 14r). A display optical system includes a see-through lens and optical elements (e.g. mirrors, filters) for seamlessly fusing virtual content with the actual direct real world view seen through the lenses of the HMD. A display optical system 14 has an optical axis which is generally in the center of the see-through lens in which light is generally collimated to provide a distortionless view. For example, when an eye care professional fits an ordinary pair of eyeglasses to an end user's face, the glasses are usually fit such that they sit on the end user's nose at a position where each pupil is aligned with the center or optical axis of the respective lens resulting in generally collimated light reaching the end user's eye for a clear or distortionless view.

As depicted in FIG. 2E, a detection area 139r, 139l of at least one sensor is aligned with the optical axis of its respective display optical system 14r, 14l so that the center of the detection area 139r, 139l is capturing light along the optical axis. If the display optical system 14 is aligned with the end user's pupil, then each detection area 139 of the respective sensor 134 is aligned with the end user's pupil. Reflected light of the detection area 139 is transferred via one or more optical elements to the actual image sensor 134 of the camera, which in the embodiment depicted is illustrated by the dashed line as being inside the frame 115.

In one embodiment, the at least one sensor 134 may be a visible light camera (e.g., an RGB camera). In one example, an optical element or light directing element comprises a visible light reflecting mirror which is partially transmissive and partially reflective. The visible light camera provides image data of the pupil of the end user's eye, while IR photodetectors 152 capture glints which are reflections in the IR portion of the spectrum. If a visible light camera is used, reflections of virtual images may appear in the eye data captured by the camera. An image filtering technique may be used to remove the virtual image reflections if desired. An IR camera is not sensitive to the virtual image reflections on the eye.

In another embodiment, the at least one sensor 134 (i.e., 134l and 134r) is an IR camera or a position sensitive detector (PSD) to which the IR radiation may be directed. The IR radiation reflected from the eye may be from incident radiation of the illuminators 153, other IR illuminators (not shown), or from ambient IR radiation reflected off the eye. In some cases, sensor 134 may be a combination of an RGB and an IR camera, and the light directing elements may include a visible light reflecting or diverting element and an IR radiation reflecting or diverting element. In some cases, the sensor 134 may be embedded within a lens of the system 14. Additionally, an image filtering technique may be applied to blend the camera into a user field of view to lessen any distraction to the user.

As depicted in FIG. 2E, there are four sets of an illuminator 153 paired with a photodetector 152 and separated by a barrier 154 to avoid interference between the incident light generated by the illuminator 153 and the reflected light received at the photodetector 152. To avoid unnecessary clutter in the drawings, drawing numerals are shown with respect to a representative pair. Each illuminator may be an infra-red (IR) illuminator which generates a narrow beam of light at about a predetermined wavelength. Each of the photodetectors may be selected to capture light at about the predetermined wavelength. Infra-red may also include near-infrared. As there can be wavelength drift of an illuminator or photodetector or a small range about a wavelength may be acceptable, the illuminator and photodetector may have a tolerance range about a wavelength for generation and detection. In some embodiments where the sensor is an IR camera or IR position sensitive detector (PSD), the photodetectors may include additional data capture devices and may also be used to monitor the operation of the illuminators, e.g. wavelength drift, beam width changes, etc. The photodetectors may also provide glint data with a visible light camera as the sensor 134.

As depicted in FIG. 2E, each display optical system 14 and its arrangement of gaze detection elements facing each eye (e.g., such as camera 134 and its detection area 139, the illuminators 153, and photodetectors 152) are located on a movable inner frame portion 117l, 117r. In this example, a display adjustment mechanism comprises one or more motors 203 having a shaft 205 which attaches to the inner frame portion 117 which slides from left to right or vice versa within the frame 115 under the guidance and power of shafts 205 driven by motors 203. In some embodiments, one motor 203 may drive both inner frames.

FIG. 2F depicts an alternative embodiment of a portion of an HMD 2 with movable display optical systems including gaze detection elements. As depicted, each display optical system 14 is enclosed in a separate frame portion 1151, 115r. Each of the frame portions may be moved separately by the motors 203. More information about HMDs with movable display optical systems can be found in U.S. patent application Ser. No. 13/250,878, entitled “Personal Audio/Visual System,” filed Sep. 30, 2011, which is herein incorporated by reference in its entirety.

FIG. 2G depicts one embodiment of a side view of a portion of an HMD 2 including an eyeglass temple 102 of the frame 115. At the front of frame 115 is a front facing video camera 113 that can capture video and still images. In some embodiments, front facing camera 113 may include a depth camera as well as a visible light or RGB camera. In one example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a CCD or other type of depth sensor. Other types of visible light cameras (e.g., an RGB camera or image sensor) and depth cameras can be used. More information about depth cameras can be found in U.S. patent application Ser. No. 12/813,675, filed on Jun. 11, 2010, incorporated herein by reference in its entirety. The data from the cameras may be sent to control circuitry 136 for processing in order to identify objects through image segmentation and/or edge detection techniques.

Inside temple 102, or mounted to temple 102, are ear phones 130, inertial sensors 132, GPS transceiver 144, and temperature sensor 138. In one embodiment, inertial sensors 132 include a three axis magnetometer, three axis gyro, and three axis accelerometer. The inertial sensors are for sensing position, orientation, and sudden accelerations of HMD 2. From these movements, head position may also be determined.

In some cases, HMD 2 may include an image generation unit which can create one or more images including one or more virtual objects. In some embodiments, a microdisplay may be used as the image generation unit. As depicted, microdisplay assembly 173 comprises light processing elements and a variable focus adjuster 135. An example of a light processing element is a microdisplay unit 120. Other examples include one or more optical elements such as one or more lenses of a lens system 122 and one or more reflecting elements such as surfaces 124. Lens system 122 may comprise a single lens or a plurality of lenses.

Mounted to or inside temple 102, the microdisplay unit 120 includes an image source and generates an image of a virtual object. The microdisplay unit 120 is optically aligned with the lens system 122 and the reflecting surface 124. The optical alignment may be along an optical axis 133 or an optical path 133 including one or more optical axes. The microdisplay unit 120 projects the image of the virtual object through lens system 122, which may direct the image light onto reflecting element 124. The variable focus adjuster 135 changes the displacement between one or more light processing elements in the optical path of the microdisplay assembly or an optical power of an element in the microdisplay assembly. The optical power of a lens is defined as the reciprocal of its focal length (i.e., 1/focal length) so a change in one effects the other. The change in focal length results in a change in the region of the field of view which is in focus for an image generated by the microdisplay assembly 173.

In one example of the microdisplay assembly 173 making displacement changes, the displacement changes are guided within an armature 137 supporting at least one light processing element such as the lens system 122 and the microdisplay 120. The armature 137 helps stabilize the alignment along the optical path 133 during physical movement of the elements to achieve a selected displacement or optical power. In some examples, the adjuster 135 may move one or more optical elements such as a lens in lens system 122 within the armature 137. In other examples, the armature may have grooves or space in the area around a light processing element so it slides over the element, for example, microdisplay 120, without moving the light processing element. Another element in the armature such as the lens system 122 is attached so that the system 122 or a lens within slides or moves with the moving armature 137. The displacement range is typically on the order of a few millimeters (mm). In one example, the range is 1-2 mm. In other examples, the armature 137 may provide support to the lens system 122 for focal adjustment techniques involving adjustment of other physical parameters than displacement. An example of such a parameter is polarization.

More information about adjusting a focal distance of a microdisplay assembly can be found in U.S. patent Ser. No. 12/941,825 entitled “Automatic Variable Virtual Focus for Augmented Reality Displays,” filed Nov. 8, 2010, which is herein incorporated by reference in its entirety.

In one embodiment, the adjuster 135 may be an actuator such as a piezoelectric motor. Other technologies for the actuator may also be used and some examples of such technologies are a voice coil formed of a coil and a permanent magnet, a magnetostriction element, and an electrostriction element.

Several different image generation technologies may be used to implement microdisplay 120. In one example, microdisplay 120 can be implemented using a transmissive projection technology where the light source is modulated by optically active material and backlit with white light. These technologies are usually implemented using LCD type displays with powerful backlights and high optical energy densities. Microdisplay 120 can also be implemented using a reflective technology for which external light is reflected and modulated by an optically active material. The illumination may be forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the system described herein. Additionally, microdisplay 120 can be implemented using an emissive technology where light is generated by the display. For example, a PicoP™ engine from Microvision, Inc. emits a laser signal with a micro mirror steering either onto a tiny screen that acts as a transmissive element or beamed directly into the eye (e.g., laser).

FIG. 2H depicts one embodiment of a side view of a portion of an HMD 2 which provides support for a three dimensional adjustment of a microdisplay assembly. Some of the numerals illustrated in the FIG. 2G above have been removed to avoid clutter in the drawing. In some embodiments where the display optical system 14 is moved in any of three dimensions, the optical elements represented by reflecting surface 124 and the other elements of the microdisplay assembly 173 may also be moved for maintaining the optical path 133 of the light of a virtual image to the display optical system. An XYZ transport mechanism in this example made up of one or more motors represented by motor block 203 and shafts 205 under control of control circuitry 136 control movement of the elements of the microdisplay assembly 173. An example of motors which may be used are piezoelectric motors. In the illustrated example, one motor is attached to the armature 137 and moves the variable focus adjuster 135 as well, and another representative motor 203 controls the movement of the reflecting element 124.

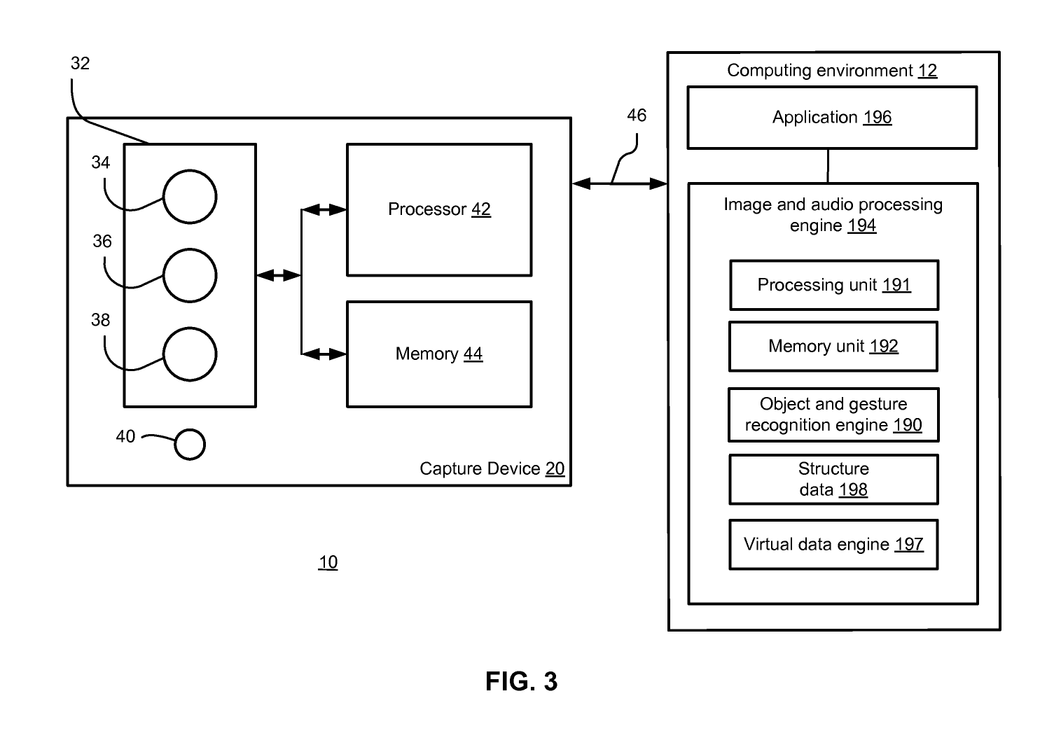

FIG. 3 depicts one embodiment of a computing system 10 including a capture device 20 and computing environment 12. In some embodiments, capture device 20 and computing environment 12 may be integrated within a single mobile computing device. The single integrated mobile computing device may comprise a mobile device, such as mobile device 19 in FIG. 1. In one example, the capture device 20 and computing environment 12 may be integrated within an HMD. In other embodiments, capture device 20 may be integrated with a first mobile device, such as mobile device 19 in FIG. 2A, and computing environment 12 may be integrated with a second mobile device in communication with the first mobile device, such as mobile device 5 in FIG. 2A.

In one embodiment, the capture device 20 may include one or more image sensors for capturing images and videos. An image sensor may comprise a CCD image sensor or a CMOS image sensor. In some embodiments, capture device 20 may include an IR CMOS image sensor. The capture device 20 may also include a depth sensor (or depth sensing camera) configured to capture video with depth information including a depth image that may include depth values via any suitable technique including, for example, time-of-flight, structured light, stereo image, or the like.

The capture device 20 may include an image camera component 32. In one embodiment, the image camera component 32 may include a depth camera that may capture a depth image of a scene. The depth image may include a two-dimensional (2D) pixel area of the captured scene where each pixel in the 2D pixel area may represent a depth value such as a distance in, for example, centimeters, millimeters, or the like of an object in the captured scene from the image camera component 32.

The image camera component 32 may include an IR light component 34, a three-dimensional (3D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more objects in the capture area using, for example, the 3D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more objects (or targets) in the capture area, the pattern may become deformed in response. Such a deformation of the pattern may be captured by, for example, the 3-D camera 36 and/or the RGB camera 38 and analyzed to determine a physical distance from the capture device to a particular location on the one or more objects. Capture device 20 may include optics for producing collimated light. In some embodiments, a laser projector may be used to create a structured light pattern. The light projector may include a laser, laser diode, and/or LED.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used, or any combination and number of cameras may be used. In one embodiment, the capture device 20 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As depicted in FIG. 3, capture device 20 may include one or more microphones 40. Each of the one or more microphones 40 may include a transducer or sensor that may receive and convert sound into an electrical signal. The one or more microphones may comprise a microphone array in which the one or more microphones may be arranged in a predetermined layout.

The capture device 20 may include a processor 42 that may be in operative communication with the image camera component 32. The processor 42 may include a standardized processor, a specialized processor, a microprocessor, or the like. The processor 42 may execute instructions that may include instructions for storing filters or profiles, receiving and analyzing images, determining whether a particular situation has occurred, or any other suitable instructions. It is to be understood that at least some image analysis and/or target analysis and tracking operations may be executed by processors contained within one or more capture devices such as capture device 20.

The capture device 20 may include a memory 44 that may store the instructions that may be executed by the processor 42, images or frames of images captured by the 3D camera or RGB camera, filters or profiles, or any other suitable information, images, or the like. In one example, the memory 44 may include random access memory (RAM), read only memory (ROM), cache, Flash memory, a hard disk, or any other suitable storage component. As depicted, the memory 44 may be a separate component in communication with the image capture component 32 and the processor 42. In another embodiment, the memory 44 may be integrated into the processor 42 and/or the image capture component 32. In other embodiments, some or all of the components 32, 34, 36, 38, 40, 42 and 44 of the capture device 20 may be housed in a single housing.

The capture device 20 may be in communication with the computing environment 12 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46. In one embodiment, the capture device 20 may provide the images captured by, for example, the 3D camera 36 and/or the RGB camera 38 to the computing environment 12 via the communication link 46.

As depicted in FIG. 3, computing environment 12 includes image and audio processing engine 194 in communication with application 196. Application 196 may comprise an operating system application or other computing application such as a gaming application. Image and audio processing engine 194 includes virtual data engine 197, object and gesture recognition engine 190, structure data 198, processing unit 191, and memory unit 192, all in communication with each other. Image and audio processing engine 194 processes video, image, and audio data received from capture device 20. To assist in the detection and/or tracking of objects, image and audio processing engine 194 may utilize structure data 198 and object and gesture recognition engine 190. Virtual data engine 197 processes virtual objects and registers the position and orientation of virtual objects in relation to various maps of a real-world environment stored in memory unit 192.

Processing unit 191 may include one or more processors for executing object, facial, and voice recognition algorithms. In one embodiment, image and audio processing engine 194 may apply object recognition and facial recognition techniques to image or video data. For example, object recognition may be used to detect particular objects (e.g., soccer balls, cars, people, or landmarks) and facial recognition may be used to detect the face of a particular person. Image and audio processing engine 194 may apply audio and voice recognition techniques to audio data. For example, audio recognition may be used to detect a particular sound. The particular faces, voices, sounds, and objects to be detected may be stored in one or more memories contained in memory unit 192. Processing unit 191 may execute computer readable instructions stored in memory unit 192 in order to perform processes discussed herein.

The image and audio processing engine 194 may utilize structural data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

The image and audio processing engine 194 may also utilize object and gesture recognition engine 190 while performing gesture recognition. In one example, object and gesture recognition engine 190 may include a collection of gesture filters, each comprising information concerning a gesture that may be performed by a skeletal model. The object and gesture recognition engine 190 may compare the data captured by capture device 20 in the form of the skeletal model and movements associated with it to the gesture filters in a gesture library to identify when a user (as represented by the skeletal model) has performed one or more gestures. In one example, image and audio processing engine 194 may use the object and gesture recognition engine 190 to help interpret movements of a skeletal model and to detect the performance of a particular gesture.

In some embodiments, one or more objects being tracked may be augmented with one or more markers such as an IR retroreflective marker to improve object detection and/or tracking. Planar reference images, coded AR markers, QR codes, and/or bar codes may also be used to improve object detection and/or tracking. Upon detection of one or more objects and/or gestures, image and audio processing engine 194 may report to application 196 an identification of each object or gesture detected and a corresponding position and/or orientation if applicable.

More information about detecting and tracking objects can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety. More information about object and gesture recognition engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool,” filed on May 29, 2009, both of which are incorporated by reference herein in their entirety.

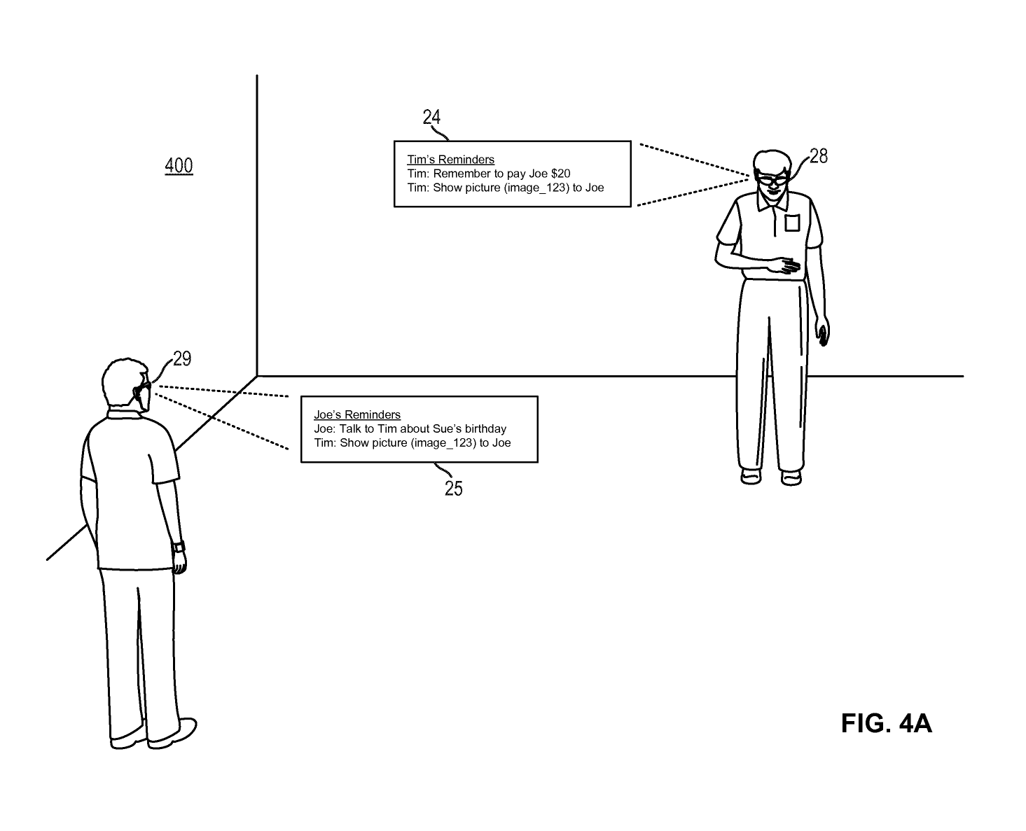

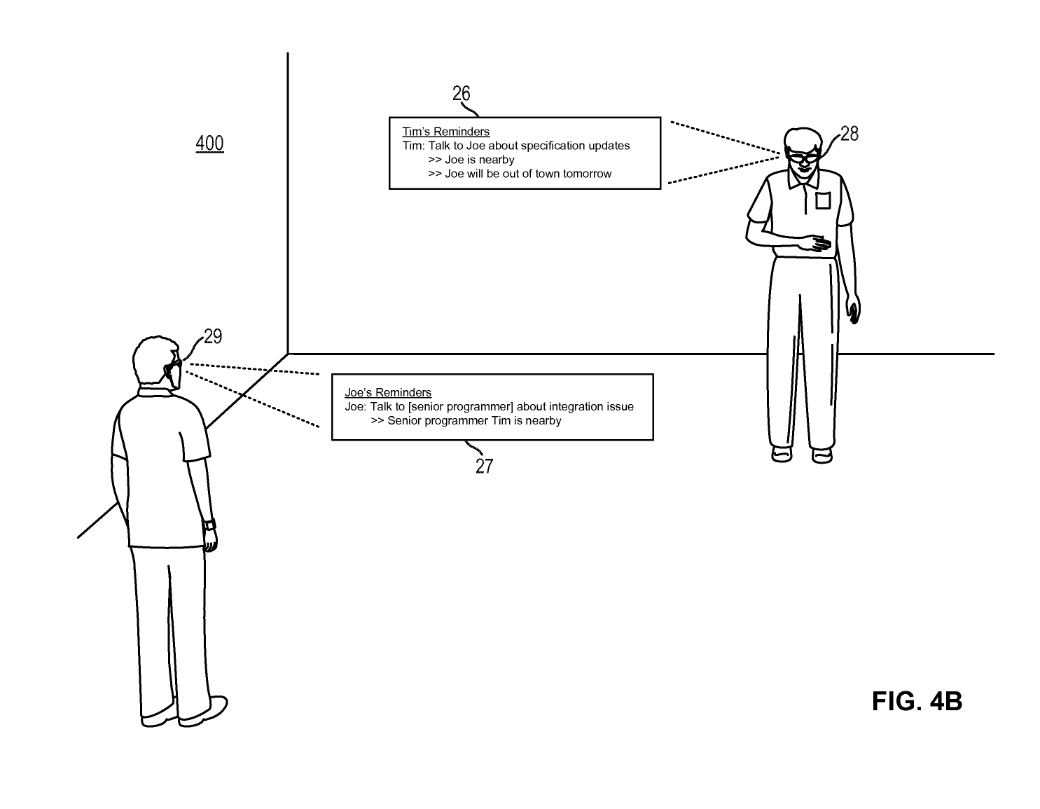

FIGS. 4A-4B depict various embodiments of various augmented reality environments in which people-triggered holographic reminders may be used. In some embodiments, an HMD may be used to generate and display an augmented reality environment to an end user of the HMD in which reminders associated with a particular person may be displayed if the particular person is within a field of view of the HMD or if the particular person is within a particular distance of the HMD.

FIG. 4A depicts one embodiment of an environment 400 in which a first end user (i.e., “Joe”) wearing an HMD 29 views an augmented reality environment that includes reminders 25 associated with both the first end user and a second end user (i.e., “Tim”) wearing a second HMD 28 within the environment 400. As depicted, reminders 25 include a first reminder corresponding with the first end user (“Joe”) to “Talk to Tim about Sue's birthday” and a second reminder corresponding with the second end user (“Tim”) to show a particular picture to Joe with a link to the picture (image_{—}123). In this case, Joe may view one of Tim's reminders that is associated with Joe. The second end user wearing the second HMD 28 may view a second augmented reality environment that includes reminders 24. As depicted, reminders 24 includes a third reminder to “Remember to pay Joe $20” and a fourth reminder to “Show picture (image_{—}123) to Joe.” Thus, reminders displayed within an augmented reality environment of an HMD may be associated with an end user of the HMD and other people who have reminders corresponding with the end user. Moreover, both the HMD 29 and the second HMD 28 may display the same reminder within their respective augmented reality environments.

FIG. 4B depicts one embodiment of an environment 400 in which a first end user (i.e., “Joe”) wearing an HMD 29 views an augmented reality environment that includes reminders 27 and a second end user (i.e., “Tim”) wearing a second HMD 28 views a second augmented reality environment that includes reminders 26. As depicted, reminders 27 include a reminder to talk to a person with a job title corresponding with that of a “senior programmer” about an integration issue and that a person with the corresponding job title (i.e., “Tim”) has been identified within a distance of the HMD 29. Reminders 26 (as displayed on HMD 28) include a reminder to “Talk to Joe about specification updates” and further includes relevant reminder information such that Joe is nearby (or within a proximity of Tim) and that Joe will be out of town beginning tomorrow. Thus, reminders may correspond with a particular person as an individual or as belonging to a particular group (e.g., a member of a group with a particular job title such as programmer or administrator).

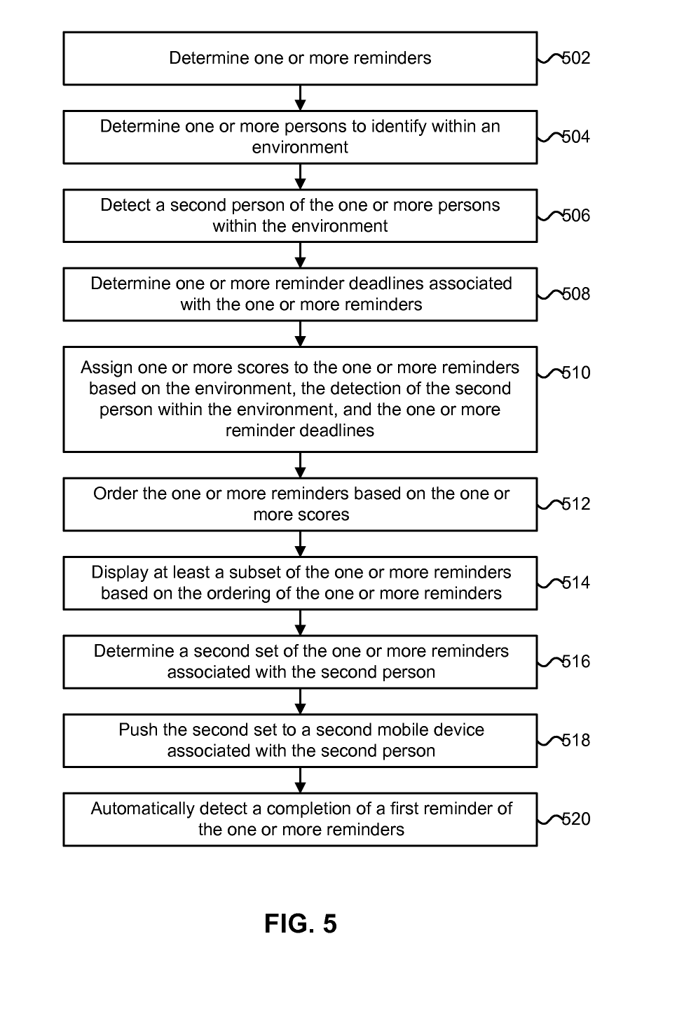

FIG. 5 is a flowchart describing one embodiment of a method for generating and displaying people-triggered holographic reminders. In one embodiment, the process of FIG. 5 may be performed by a mobile device, such as mobile device 19 in FIG. 1.

In step 502, one or more reminders are determined. The one or more reminders may be determined based on tasks entered into or accessible from a personal information manager, task manager, email application, calendar application, social networking application, online database application, software bug tracking application, issue tracking application, and/or time management application. In some cases, the one or more reminders may be automatically generated using information accessible from an online database (e.g., a social networking database). For example, birthday information acquired from a social networking database or application associated with friends (or contacts) of an end user may be used to generate birthday reminders automatically without involvement from the end user. Each of the one or more reminders may correspond with a particular task to be completed, one or more people associated with the particular task, a location associated with the particular task, a reminder frequency (e.g., that a particular reminder is issued every two weeks), and/or a completion time for the particular task. The one or more people associated with a particular task may include a particular person who may be identified individually or identified as belonging to a particular group (e.g., a member of a group with a particular job title such as programmer or administrator).

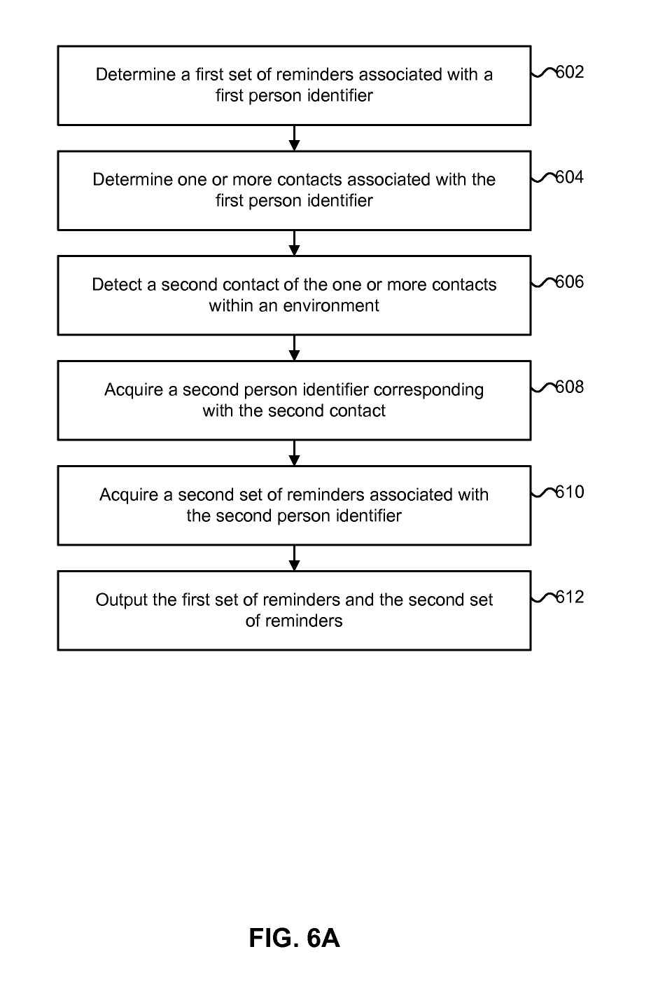

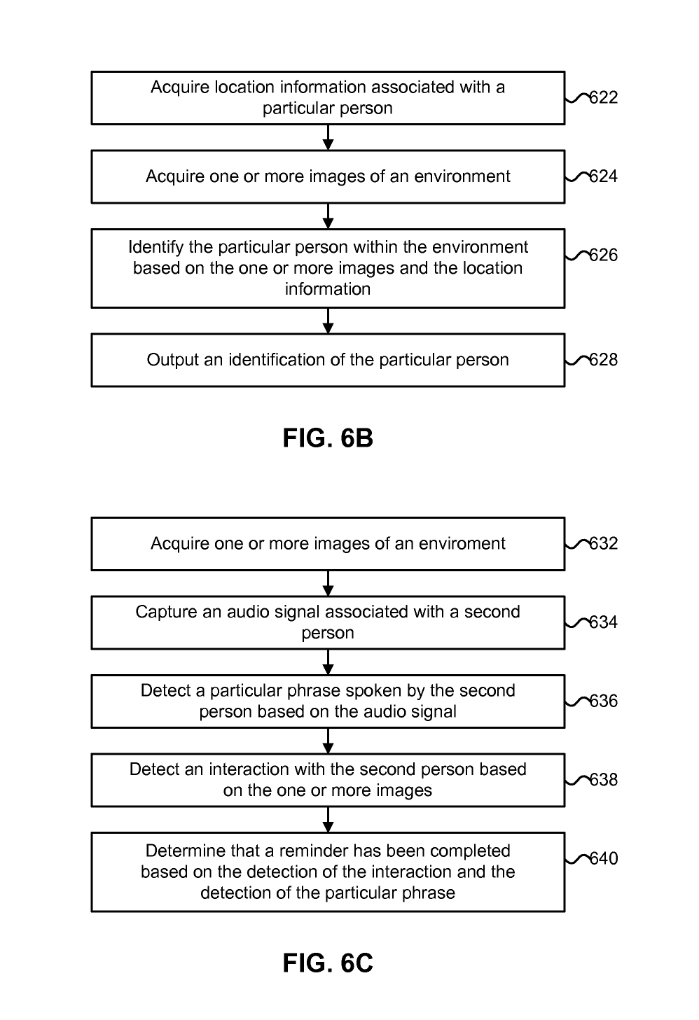

In one embodiment, an end user of an HMD may enter one or more reminders into a personal information management application using a laptop computer, desktop computer, mobile phone, or other computing device. The end user of the HMD may also enter one or more reminders into a personal information management application running on the HMD using voice commands and/or gestures. For example, the end user of the HMD may issue a voice command such as “remind me about the concert when I see my parents.” In one embodiment, the one or more reminders may include reminders corresponding with an end user of an HMD, as well as other reminders corresponding with other persons within an environment that are associated with the end user (e.g., the end user's boss has a reminder to discuss a project with the end user). One embodiment of a process for determining one or more reminders is described later in reference to FIG. 6A.

In step 504, one or more persons to identify within an environment are determined. The one or more persons to identify within an environment may include one or more people associated with a particular reminder. In one example, if the particular reminder includes congratulating a particular person for receiving an award, then the one or more persons to identify may include the particular person. In some cases, the one or more persons to identify may be identified using facial recognition techniques.

In step 506, a second person of the one or more persons is detected within the environment. The second person may be detected using facial recognition techniques and/or voice recognition techniques. The second person may also be detected within the environment by detecting a second mobile device corresponding with the second person within the environment. In some embodiments, the second person may correspond with a user identifier and detecting the second person within the environment includes determining that a person within the environment is associated with the user identifier. One embodiment of a process for detecting a second person within an environment is described later in reference to FIG. 6B.

In step 508, one or more reminder deadlines associated with the one or more reminders are determined. The one or more reminder deadlines may include a completion time (or time period) within which to complete a particular task. In step 510, one or more scores are assigned to the one or more reminders based on the environment, the detection of the second person within the environment, and the one or more reminder deadlines. In one embodiment, an identification of the environment may be used to weigh a subset of the one or more reminders. For example, reminders associated with a work environment may be weighed more heavily (and therefore lead to higher scores) when an end user of an HMD is within the work environment. Reminders corresponding with particular people within the environment (e.g., a spouse or manager of the end user) and/or reminder deadlines that are within a particular time frame (e.g., must be completed within the next two days) may be given higher scores in relation to other reminders.

In step 512, the one or more reminders are ordered based on the one or more scores. In one embodiment, the one or more reminders are ordered in a descending order from reminders with the highest scores to reminders with the lowest scores. In step 514, at least a subset of the one or more reminders are displayed based on the ordering of the one or more reminders. In one embodiment, the at least a subset of the one or more reminders may be displayed using an HMD. In another embodiment, the at least a subset of the one or more reminders may be displayed using a tablet computing device or other non-HMD type of computing device.

In step 516, a second set of the one or more reminders associated with the second person are determined. In step 518, the second set of the one or more reminders are pushed to a second mobile device associated with the second person. In one example, the second set of the one or more reminders may be transmitted to the second mobile device via a wireless connection (e.g., a WiFi connection). In some embodiments, the second set may be pushed to the second mobile device if the second person is within a field of view of an HMD or if the second person is within a particular distance of the HMD (e.g., within 100 meters of the HMD).

In step 520, a completion of a first reminder of the one or more reminders is automatically detected. In some embodiments, a completion of a reminder may be automatically detected by applying speech recognition techniques (e.g., to identify key words, phrases, or names) to captured audio of a conversation occurring between the end user and the particular person. The completion of the first reminder may also be detected upon the explicit selection of a user interface button by the end user or by an issuance of a voice command by the end user (e.g., the end user may say “reminder regarding the concert is completed”). Once a reminder has been deemed to have been completed, it may be removed from the one or more reminders. One embodiment of a process for automatically detecting the completion of a reminder is described later in reference to FIG. 6C.

In one embodiment, a first reminder of the one or more reminders may be automatically removed if a time period associated with the first reminder has elapsed or a completion date associated with the first reminder has passed. For example, if the first reminder has a completion date assigned to a friend's birthday, then the first reminder may be automatically removed the day after the friend's birthday.

FIG. 6A is a flowchart describing one embodiment of a process for determining one or more reminders. The process described in FIG. 6A is one example of a process for implementing step 502 in FIG. 5. In one embodiment, the process of FIG. 6A may be performed by a mobile device, such as mobile device 19 in FIG. 1.

In step 602, a first set of reminders associated with a first person identifier is determined. The first person may correspond with an end user of an HMD and the first person identifier may comprise an alphanumeric user identifier associated with the first person. In step 604, one or more contacts associated with the first person identifier are determined. The one or more contacts may correspond with contacts entered into a personal information management application, an e-mail or calendar application, and/or a social networking application associated with the first person.

In step 606, a second contact of the one or more contacts is detected within an environment. In one embodiment, the second contact may be detected within the environment using facial recognition techniques and/or voice recognition techniques. In another embodiment, the second contact may be detected within the environments if a second mobile device associated with the second contact is detected within the environment. The second mobile device may be deemed to be within the environment if the second mobile device is within a particular distance of an HMD (e.g., determined using GPS location information corresponding with both the second mobile device and the HMD).

In step 608, a second person identifier corresponding with the second contact is acquired. The second person identifier may comprise an alphanumeric user identifier associated with the second contact. In one embodiment, a table lookup is used to map the identification of the second contact with the second person identifier (or more than one second person user identifiers).

In step 610, a second set of reminders associated with the second person identifier are acquired. In one embodiment, the second set of reminders are acquired from a second mobile device associated with the second contact. In some cases, the second mobile device may comprise a second HMD. In step 612, the first set of reminders and the second set of reminders are outputted.

FIG. 6B is a flowchart describing one embodiment of a process for detecting a second person within an environment. The process described in FIG. 6B is one example of a process for implementing step 506 in FIG. 5. In one embodiment, the process of FIG. 6B may be performed by a mobile device, such as mobile device 19 in FIG. 1.

In step 622, location information associated with a particular person is acquired. The location information may comprise GPS coordinates associated with a mobile device used by the particular person. The location information may also comprise depth information or a distance of the particular person from an HMD. In step 624, one or more images of an environment are acquired. The one or more images may be captured using a capture device, such as capture device 213 in FIG. 2B. The one or more images may comprise color images and/or depth images. In step 626, the particular person within the environment is identified based on the one or more images and the location information. In one embodiment, facial recognition techniques may be applied to the one or more images if a location of the particular person is within a particular distance of an HMD (e.g., within 100 meters). In another embodiment, facial recognition is performed using the one or more images for each person associated with one or more reminders stored on an HMD. In step 628, an identification of the particular person is outputted. In one example, a user identifier associated with the particular person may be outputted.

FIG. 6C is a flowchart describing one embodiment of a process for automatically detecting the completion of a reminder. The process described in FIG. 6C is one example of a process for implementing step 520 in FIG. 5. In one embodiment, the process of FIG. 6C may be performed by a mobile device, such as mobile device 19 in FIG. 1.

In step 632, one or more images of an environment are acquired. The one more images may be captured using a capture device, such as capture device 213 in FIG. 2B. In step 634, an audio signal associated with a second person is captured. The audio signal may be captured using a capture device, such as capture device 213 in FIG. 2B. In step 636, a particular phrase spoken by the second person is detected based on the audio signal. The particular phrase may be detected using audio signal processing techniques and/or speech recognition techniques.

In step 638, an interaction with the second person is detected based on the one or more images. In one embodiment, the interaction may include the second person facing towards an end user of an HMD, the second person speaking towards the end user of the HMD, and/or the second person shaking the hand of the end user of the HMD. In step 640, it is determined that a reminder has been completed based on the detection of the interaction and the detection of the particular phrase. In one embodiment, the interaction may comprise the second person facing towards the end user of the HMD and saying the particular phrase. In some cases, the particular phrase may include a project codename and/or a particular person's name.

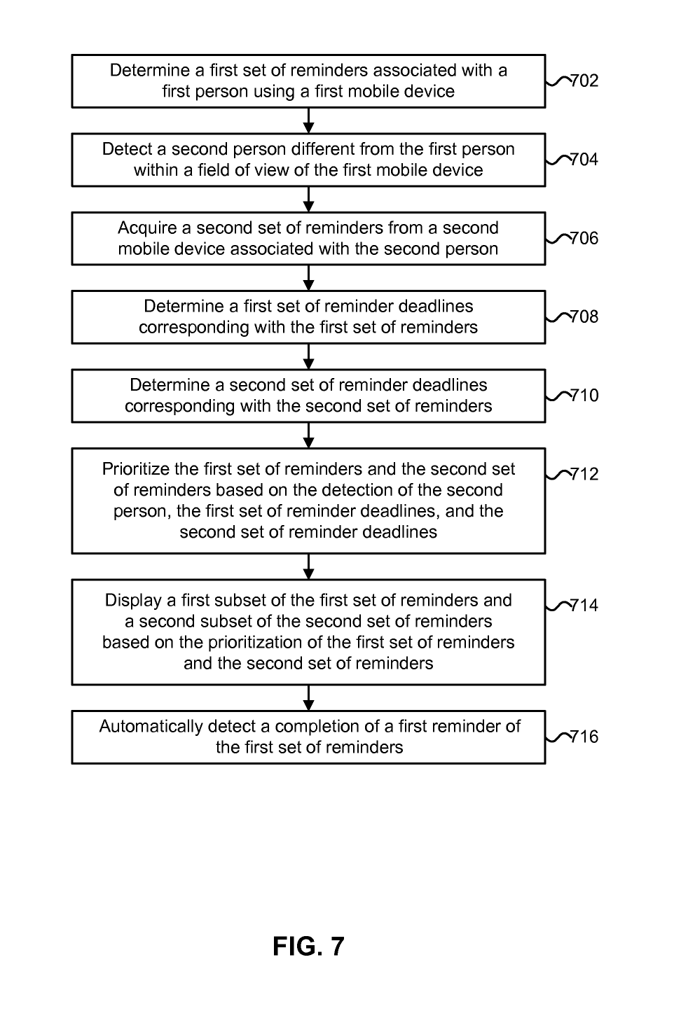

FIG. 7 is a flowchart describing an alternative embodiment of a method for generating and displaying people-triggered holographic reminders. In one embodiment, the process of FIG. 7 may be performed by a mobile device, such as mobile device 19 in FIG. 1.

In step 702, a first set of reminders associated with a first person using a first mobile device is determined. The first set of reminders may be determined based on tasks entered into or accessible from a personal information manager, task manager, email application, calendar application, social networking application, and/or time management application corresponding with the first person. The first set of reminders may also be determined based on tasks entered into work-related applications, such as a software bug tracking application or issue tracking application, that tag or are otherwise associated with the first person. In some cases, the first set of reminders may be automatically generated using information accessible from an online database (e.g., a social networking database). For example, birthday information acquired from a social networking database or application associated with friends (or contacts) of the first person may be used to generate birthday reminders automatically without involvement from the first person. The first set of reminders may correspond with a first set of tasks to be completed, one or more people associated with each of the first set of tasks to be completed, a reminder frequency (e.g., that a particular reminder is issued every two weeks), and/or completion times (or deadlines) corresponding with each of the first set of tasks to be completed. The one or more people may be identified individually or identified as belonging to a particular group (e.g., a member of a group with a particular job title such as programmer or administrator).

In step 704, a second person different from the first person is detected within a field of view of the first mobile device. The first mobile device may comprise an HMD. The second person may be detected within the field of view of the first mobile device by applying object recognition and/or facial recognition techniques to images captured by the HMD. In step 706, a second set of reminders are acquired from a second mobile device associated with the second person. In some cases, the second mobile device may comprise a second HMD associated with the second person.

In step 708, a first set of reminder deadlines corresponding with the first set of reminders is determined. In step 710, a second set of reminder deadlines corresponding with the second set of reminders is determined. A reminder deadline may include a completion time (or time period) within which to complete a particular task. In step 712, the first set of reminders and the second set of reminders are prioritized based on the detection of the second person, the first set of reminder deadlines, and the second set of reminder deadlines. In one embodiment, each reminder in the first set of reminders and the second set of reminders is assigned a score. In some cases, scores may only be assigned to the second set of reminders if the second person is determined to be within a particular distance of the first person or within a particular distance of the first mobile device. In one example, reminders associated with the second person may be weighed more heavily (and therefore lead to higher scores) as the second person comes closer to the first mobile device. The prioritization of the first set of reminders and the second set of reminders may be based on a distance between the first mobile device and the second mobile device, and whether the first set of reminder deadlines and/or the second set of reminder deadlines are within a particular time frame (e.g., must be completed within the next two days).

In step 714, a first subset of the first set of reminders and a second subset of the second set of reminders are displayed based on the prioritization of the first set of reminders and the second set of reminders. In one embodiment, the first subset associated with the first person and the second subset associated with the second person may be displayed to the first person using the first mobile device. The first mobile device may comprise an HMD. In some cases, one or more virtual objects corresponding with the second set of reminders may be displayed to first person using the first mobile device. In one example, the one or more virtual objects may provide reminder information that the second person would like to speak with the first person regarding a particular topic. In another example, the one or more virtual objects may provide task related information (e.g., if and when the second person will be on vacation next or the next meeting in which both the first person and the second person will be participants). The one or more virtual objects may also provide links to content (e.g., a photo or image) to be shared between the first person and the second person. The one or more virtual objects may also provide links to online shopping websites to help complete a particular task (e.g., buying a gift for the second person).

In step 716, a completion of a first reminder of the first set of reminders is automatically detected. In some embodiments, the completion of the first reminder may be automatically detected by applying speech recognition techniques (e.g., to identify key words, phrases, or names) to captured audio of a conversation occurring between the first person and the second person. The completion of the first reminder may also be detected upon the explicit selection of a user interface button by the first person or by an issuance of a voice command by the first person (e.g., the first person may say “reminder regarding the concert is completed”). Once the first reminder has been deemed to have been completed, it may be removed from the first set of reminders.

In some embodiments, the completion of a reminder may trigger an HMD to prompt the end user of the HMD to send a follow up message to a particular person associated with the reminder. For example, if an end user owes the particular person money, then the HMD may ask the end user if they would like to send a message to the particular person stating that “the check is in the mail.” In some cases, the format of the message or the type of message to be sent to the particular person (e.g., an email or text message) may depend on the types of computing devices used by the particular person (e.g., another HMD).

In some embodiments, an HMD may acquire a second set of reminders associated with a particular person different from the end user of the HMD from a second mobile device associated with the particular person and provide an augmented reality environment to the end user in which the second set of reminders (or a subset thereof) may be displayed if the particular person is within a field of view of the HMD or if the particular person is within a particular distance of the HMD. In some cases, one or more virtual objects corresponding with the second set of reminders may be displayed to the end user. In one example, the one or more virtual objects may provide reminder information that the particular person has a reminder to speak with the end user regarding a particular topic. In another example, the one or more virtual objects may provide task related information (e.g., if and when the particular person will be on vacation next or the next meeting in which both the end user and the particular person will be participants). The one or more virtual objects may also provide links to content (e.g., a photo or image) to be shared between the end user and the particular person.

One embodiment of the disclosed technology includes determining a first set of reminders associated with a first person using the mobile device, detecting a second person different from the first person within a field of view of the mobile device, acquiring a second set of reminders from a second mobile device associated with the second person, determining a first set of reminder deadlines corresponding with the first set of reminders, prioritizing the first set of reminders and the second set of reminders based on an identification of the second person and the first set of reminder deadlines, and displaying a first subset of the first set of reminders and a second subset of the second set of reminders based on the prioritization of the first set of reminders and the second set of reminders.

One embodiment of the disclosed technology includes a memory, one or more processors in communication with the memory, and a see-through display in communication with the one or more processors. The memory stores a first set of reminders associated with a first person using the electronic device. The one or more processors detect a second person within a field of view of the electronic device, acquire a second set of reminders associated with the second person, and prioritize the first set of reminders and the second set of reminders based on the detection of the second person. The see-through display displays the augmented reality environment including one or more virtual objects corresponding with a subset of the first set of reminders and the second set of reminders based on the prioritization of the first set of reminders and the second set of reminders.

One embodiment of the disclosed technology includes determining one or more reminders associated with an end user of an HMD, determining an identification of a second person different from the end user within a field of view of the HMD, assigning one or more scores to the one or more reminders based on the identification of the second person, ordering the one or more reminders based on the one or more scores, and displaying one or more virtual objects within an augmented reality environment using the HMD, the one or more virtual objects corresponding with a subset of the one or more reminders based on the ordering of the one or more reminders.

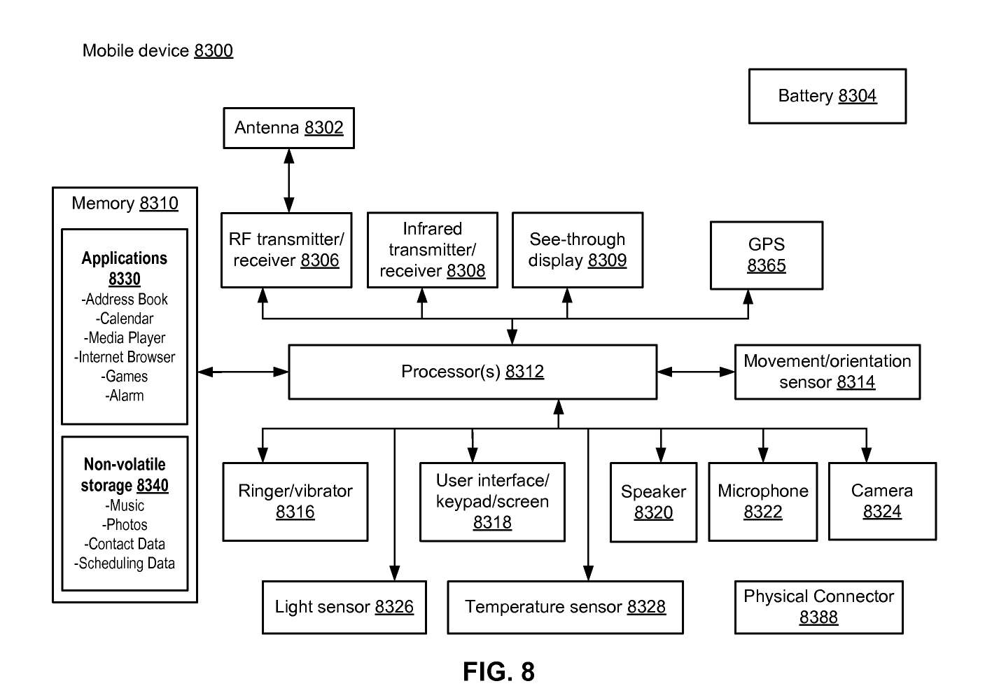

FIG. 8 is a block diagram of one embodiment of a mobile device 8300, such as mobile device 19 in FIG. 1. Mobile devices may include laptop computers, pocket computers, mobile phones, HMDs, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 are in communication with a see-through display 8309. The see-through display 8309 may display one or more virtual objects associated with a real-world environment. The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electronic device for displaying an augmented reality environment, comprising:
a memory, the memory stores a first set of reminders associated with a first person using the electronic device;
one or more processors in communication with the memory, the one or more processors detect a second person within a field of view of the electronic device, the one or more processors acquire a second set of reminders associated with the second person, the one or more processors prioritize the first set of reminders and the second set of reminders based on the detection of the second person; and
a see-through display in communication with the one or more processors, the see-through display displays the augmented reality environment including one or more virtual objects corresponding with a subset of the first set of reminders and the second set of reminders based on the prioritization of the first set of reminders and the second set of reminders.

2. The electronic device of claim 1, wherein:
the one or more processors determine a distance between the second person and the electronic device, the one or more processors prioritize the first set of reminders and the second set of reminders based on the distance between the second person and the electronic device.

3. The electronic device of claim 1, wherein:
the one or more processors determine a first set of reminder deadlines associated with the first set of reminders and a second set of reminder deadlines associated with the second set of reminders, the one or more processors prioritize the first set of reminders and the second set of reminders based on the first set of reminder deadlines and the second set of reminders deadlines.

4. The electronic device of claim 1, wherein:
the one or more processors determine a subset of the first set of reminders associated with the second person, the one or more processors push the subset to a second mobile device associated with the second person.

5. The electronic device of claim 1, wherein:
the one or more processors automatically detect a completion of a first reminder of the first set of reminders.

6. The electronic device of claim 1, wherein:
the one or more processors detect the second person by identifying that the second person is a member of a group with a particular group.

7. The electronic device of claim 1, wherein:
the electronic device comprises an HMD.

8. A method for generating and displaying people-triggered holographic reminders, comprising:
determining one or more reminders associated with an end user of an HMD;
determining an identification of a second person different from the end user within a field of view of the HMD;
assigning one or more scores to the one or more reminders based on the identification of the second person;
ordering the one or more reminders based on the one or more scores; and
displaying one or more virtual objects within an augmented reality environment using the HMD, the one or more virtual objects corresponding with a subset of the one or more reminders based on the ordering of the one or more reminders.

9. The method of claim 8, further comprising:
determining a distance between the second person and the HMD, the assigning one or more scores includes assigning one or more scores to the one or more reminders based on the identification of the second person and the distance between the second person and the HMD.

10. The method of claim 8, further comprising:
determining one or more reminder deadlines associated with the one or more reminders, the assigning one or more scores includes assigning one or more scores to the one or more reminders based on the one or more reminder deadlines and the identification of the second person.

11. The method of claim 8, further comprising:
determining a second set of the one or more reminders associated with the second person; and
pushing the second set to a second mobile device associated with the second person.

12. The method of claim 8, further comprising:
automatically detecting a completion of a first reminder of the one or more reminders.

13. The method of claim 8, further comprising:
determining one or more contacts associated with the end user;
detecting a second contact of the one or more contacts within the field of view of the HMD; and
acquiring a second set of reminders associated with the second contact, the displaying one or more virtual objects includes displaying a first virtual object corresponding with a first reminder of the second set of reminders.

14. The method of claim 8, wherein:
the determining an identification of a second person includes determining that the second person is associated with a particular group; and
the determining one or more reminders includes automatically generating at least one of the one or more reminders using information accessible from a database.

15. One or more storage devices containing processor readable code for programming one or more processors to perform a method for controlling an augmented reality environment associated with a mobile device comprising the steps of:
determining a first set of reminders associated with a first person using the mobile device;
detecting a second person different from the first person within a field of view of the mobile device;
acquiring a second set of reminders from a second mobile device associated with the second person;
determining a first set of reminder deadlines corresponding with the first set of reminders;
prioritizing the first set of reminders and the second set of reminders based on an identification of the second person and the first set of reminder deadlines; and
displaying a first subset of the first set of reminders and a second subset of the second set of reminders based on the prioritization of the first set of reminders and the second set of reminders.

16. The one or more storage devices of claim 15, further comprising:
determining a distance between the second person and the mobile device, the prioritizing includes assigning one or more scores to the first set of reminders based on the identification of the second person and the distance between the second person and the mobile device.

17. The one or more storage devices of claim 15, further comprising:
determining one or more reminder deadlines associated with the first set of reminders, the prioritization includes assigning one or more scores to the first set of reminders based on the one or more reminder deadlines and the identification of the second person.

18. The one or more storage devices of claim 15, further comprising:
determining a second set of the first set of reminders associated with the second person; and
pushing the second set to the second mobile device.

19. The one or more storage devices of claim 15, further comprising:
automatically detecting a completion of a first reminder of the first set of reminders.

20. The one or more storage devices of claim 15, wherein:
the determining a first set of reminders includes detecting a voice command from the first person.
